(19) United States
(12) Patent Application Publication
(10) Pub. No.: US 2025/0173610 A1
(43) Pub. Date: May 29, 2025

(54) SUPPORT DEVICE, SUPPORT METHOD, AND SUPPORT PROGRAM

(71) Applicant: Nippon Telegraph and Telephone Corporation, Tokyo (JP)

(72) Inventors: Misa FUKAI, Musashino-shi, Tokyo (JP); Masashi TADOKORO, Musashino-shi, Tokyo (JP); Haruo OISHI, Musashino-shi, Tokyo (JP)

(21) Appl. No.: 18/841,773

(22) PCT Filed: Mar. 2, 2022
(86) PCT No.: PCT/JP2022/008961

§ 371 Date: Aug. 27, 2024

(51) Int. Cl. G06N 20/00

(52) U.S. Cl. CPC G06N 20/00

(57) ABSTRACT

An assistance device of an embodiment acquires environment information for a task and action information regarding an action in the task. The assistance device extracts the environment information and the action information. The assistance device generates an action series processed to be more effective for learning an action on the basis of the environment information and the action information. The assistance device designs an environment and a reward in reinforcement learning of a model for executing the task on the basis of a combination of the environment information and the action, and information regarding processing. In addition, the assistance device performs preliminary learning of what kind of action is appropriate by using the action series generated in a generation process and then performs the reinforcement learning of the model on the basis of the environment and the reward designed in a design process.

### TECHNICAL FIELD

The present invention relates to an assistance device, an assistance method, and an assistance program.

### BACKGROUND ART

Reinforcement learning is one type of machine learning, and is a method in which an agent (a subject that acts) takes various actions with respect to an environment (a target on which the actions are taken) and learns an optimal action from trial and error.

A technology has been proposed for applying reinforcement learning to a task and assisting task automation and the like. In this technology, environment information on a worker during a task and information on an action taken for the environment are acquired from a camera, a microphone, a sensor, a terminal operated by the worker, or the like, and are associated with each other, whereby an environment is constructed for designing and learning a reward necessary for reinforcement learning.

### CITATION LIST

### Non Patent Literature

Non Patent Literature 1: Misa Fukai, Masashi Tadokoro, Haruo Oishi, “Study on Automating Decision-Making by Learning Optimal Processes from PC Work”, IS1-5, APNOMS 2021 (2021).

### SUMMARY OF INVENTION

### Technical Problem

However, an environment in a task and an action taken by a worker are very complicated, and there is a case where a correct action cannot be achieved only by causing an agent to perform trial and error, and learning does not progress.

In addition, there is also a method of causing an agent to perform preliminary learning in advance an action taken by the worker before the agent performs a search, but the action of the worker is not necessarily optimal, and there is a case where noise such as meaningless action or a machine operation mistake is included. For this reason, there has been a problem that efficient learning is not performed in application of reinforcement learning for a task.

The present invention has been made in view of the above, and an object of the present invention is to provide an assistance device, an assistance method, and an assistance program that implement efficient learning in reinforcement learning for a task.

### Solution to Problem

To solve the problem described above and achieve the object, an assistance device includes: an acquisition unit that acquires environment information that is information regarding an environment in a task and action information that is information regarding an action in the task; an extraction unit that extracts the environment information and the action information in association with each other; a generation unit that generates an action series processed to be more effective for learning an action up to execution of processing related to the task, from actions included in the action information, on the basis of the environment information and the action information; a design unit that designs an environment and a reward in reinforcement learning of a model for executing the task on the basis of a combination of the environment information and the action information associated with each other by the extraction unit, and information regarding processing performed by the generation unit; and a learning unit that performs preliminary learning of what kind of action is appropriate by using the action series generated by the generation unit and then performs the reinforcement learning of the model on the basis of the environment and the reward designed by the design unit.

### Advantageous Effects of Invention

According to the present invention, efficient learning in reinforcement learning for a task is implemented.

### BRIEF DESCRIPTION OF DRAWINGS

FIG. 1 is a diagram illustrating a configuration example of an assistance device of a first embodiment.

FIG. 2 is a diagram illustrating an example of environment information and action information.

FIG. 3 is a diagram illustrating an example of the environment information and the action information.

FIG. 4 is a diagram illustrating an example of the environment information and the action information.

FIG. 5 is a diagram illustrating an example of the environment information and the action information.

FIG. 6 is a diagram for describing processing performed by a generation unit.

FIG. 7 is a diagram illustrating examples of environment design and action design.

FIG. 8 is a flowchart illustrating a flow of acquisition processing.

FIG. 9 is a flowchart illustrating a flow of extraction processing.

FIG. 10 is a flowchart illustrating an example of a flow of action deletion processing.

FIG. 11 is a flowchart illustrating an example of the flow of the action deletion processing.

FIG. 12 is a flowchart illustrating a flow of processing of minimizing the number of steps of actions.

FIG. 13 is a flowchart illustrating a flow of learning processing.

FIG. 14 is a flowchart illustrating a flow of execution processing.

FIG. 15 is a diagram illustrating an example of a computer that executes an assistance program.

### DESCRIPTION OF EMBODIMENTS

Hereinafter, embodiments of an assistance device, an assistance method, and an assistance program according to the present application will be described in detail with reference to the drawings. Note that the present invention is not limited to the embodiments described below.

Conventionally, reinforcement learning of a model for assisting in a task is performed by using an environment in which the task is actually performed. In such a case, it is conceivable that an adverse effect on the task occurs. On the other hand, according to the embodiments, it is possible to perform the reinforcement learning of the model for assisting in the task while suppressing the adverse effect on the task.

Note that the task in the embodiments includes any tasks performed by humans. For example, the task includes input work to a terminal device such as a personal computer (PC), response to an inquiry from a customer by voice, text, or the like, inspection of equipment, and the like.

For example, a model for automating the input work to the terminal device automatically performs an operation imitating human input work on the terminal device on the basis of a captured image of a screen displayed by the terminal device. In addition, the model may use, for example, a neural network.

### Configuration of First Embodiment

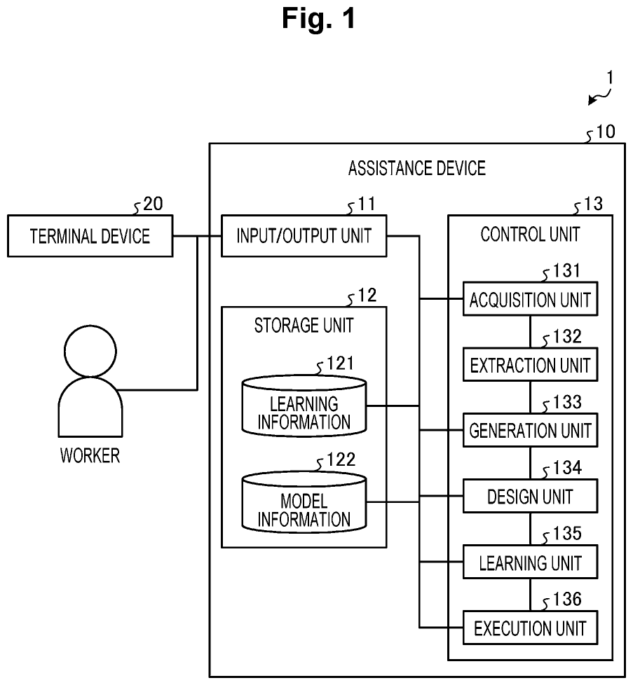

First, a configuration of an assistance device according to a first embodiment will be described with reference to FIG. 1. FIG. 1 is a diagram illustrating an example of the configuration of the assistance device according to the first embodiment.

As illustrated in FIG. 1, an assistance system 1 includes an assistance device 10 and a terminal device 20. The assistance device 10 is connected to the terminal device 20. The terminal device 20 is a device such as a PC for a worker to perform work related to a task. In addition, the assistance device 10 may be connected to a camera, a microphone, a wearable device, or the like of the worker.

Here, each of units of the assistance device 10 will be described. As illustrated in FIG. 1, the assistance device 10 includes an input/output unit 11, a storage unit 12, and a control unit 13.

The input/output unit 11 is an interface for inputting and outputting data. For example, the input/output unit 11 is a network interface card (NIC). The input/output unit 11 can transmit/receive data to/from another device.

In addition, the input/output unit 11 may be connected to input devices such as a mouse and a keyboard. In addition, the input/output unit 11 may be connected to output devices such as a display and a speaker.

The storage unit 12 is a storage device such as a hard disk drive (HDD), a solid state drive (SSD), or an optical disk. Note that the storage unit 12 may be a data-rewritable semiconductor memory such as a random access memory (RAM), a flash memory, or a non volatile static random access memory (NVSRAM).

The storage unit 12 stores an operating system (OS) and various programs executed by the assistance device 10. The storage unit 12 stores learning information 121 and model information 122.

The learning information 121 is information for performing reinforcement learning. The learning information 121 includes a reward and an environment in the reinforcement learning.

The model information 122 is information such as parameters for constructing a model for assisting in a task. In a case where the model is a neural network, the model information 122 includes a weight, a bias, and the like for each of nodes.

Note that the model receives an input of information indicating a work environment and outputs information regarding an action. The assistance device 10 assists in work on the basis of the output information.

The control unit 13 controls the entire assistance device 10. The control unit 13 is, for example, an electronic circuit such as a central processing unit (CPU), a micro processing unit (MPU), or a graphics processing unit (GPU), or an integrated circuit such as an application specific integrated circuit (ASIC) or a field programmable gate array (FPGA).

In addition, the control unit 13 includes an internal memory for storing programs and control data defining various processing procedures, and executes pieces of processing by using the internal memory. In addition, various programs operate, whereby the control unit 13 functions as various processing units. For example, the control unit 13 includes an acquisition unit 131, an extraction unit 132, a generation unit 133, a design unit 134, a learning unit 135, and an execution unit 136.

The acquisition unit 131 acquires environment information that is information regarding an environment in a task and action information that is information regarding an action in the task.

The acquisition unit 131 can acquire information regarding an action of a worker who performs the task as the action information, and can acquire information on an environment regarding the worker as the environment information. In addition, the acquisition unit 131 can acquire a content of an operation on the terminal device 20 by the worker as the action information, and can acquire a state of the terminal device 20 that changes depending on the operation by the worker as the environment information.

For example, the acquisition unit 131 acquires, as the environment information, an image in a viewpoint direction of the worker captured by the camera and a voice around the worker collected by the microphone.

In addition, for example, the acquisition unit 131 acquires, as the environment information, information on an image, a voice, and the like output from the terminal device 20 operated by the worker.

The image acquired by the acquisition unit 131 may be a still image such as a captured image or may be a moving image. In addition, the acquisition unit 131 may acquire the collected voice as a voice file, or may acquire text obtained by converting the collected voice.

For example, the acquisition unit 131 acquires, as the action information, information on the worker's body movement sensed by a sensor attached to the worker, and the worker's utterance content collected by the microphone.

In addition, for example, the acquisition unit 131 acquires, as the action information, the content of the operation performed on the terminal device 20 by the worker. The content of the operation is a time when the keyboard is hit, a type of a hit key, a locus of movement of the mouse, a position and a time when the mouse is clicked, and the like.

At this time, the acquisition unit 131 can acquire operation content on the terminal device 20 by the worker as the action information, and acquire a captured image of a screen of the terminal device 20 that changes depending on the operation as the environment information.

Furthermore, the acquisition unit 131 may acquire, as the action information, information for identifying an application or a window operated by the worker on the terminal device 20 together with the operation content.

The extraction unit 132 extracts the environment information and the action information in association with each other. In other words, the extraction unit 132 extracts a combination of the environment information and the action information acquired by the acquisition unit 131.

The extraction unit 132 can extract action information regarding an action in the task and environment information regarding at least one of an environment before the action is taken or an environment affected by the action in association with each other.

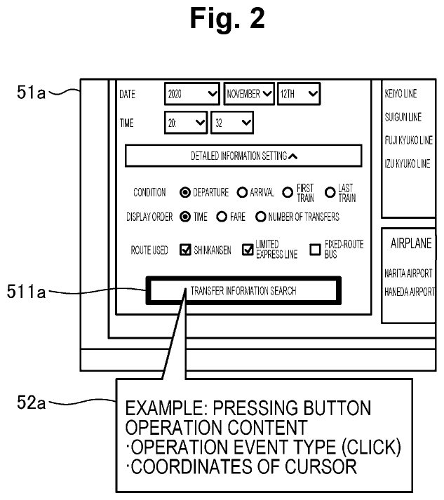

Association between the environment information and the action information will be described with reference to FIGS. 2 to 5. FIGS. 2, 3, 4, and 5 are diagrams illustrating examples of the environment information and the action information.

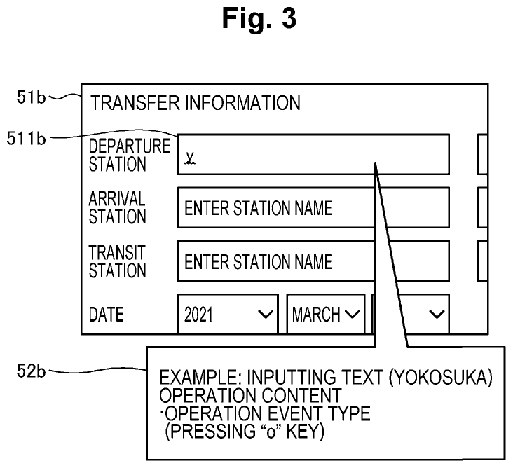

FIGS. 2 and 3 illustrate examples of the environment information and the action information regarding a task using the terminal device 20.

In the example of FIG. 2, the extraction unit 132 extracts a captured image 51a and operation content 52a in association with each other. The captured image 51a corresponds to the environment information. The operation content 52a corresponds to the action information.

It is assumed that the worker performs input to various items and clicks (presses) a button 511a with the mouse. In this case, the operation content 52a includes that a type of an operation event is a click and coordinates of a cursor when the click is performed.

In this case, for example, the environment before the action is taken is a captured image of the screen before the button 511a is pressed. On the other hand, the environment affected by the action is a captured image of the screen to which transition is performed after the button 511a is pressed.

Note that the extraction unit 132 may extract the entire captured image 51a as the environment information, or may extract the button 511a that is a part of the captured image 51a and is an operation target as the environment information.

Note that the captured image 51a in FIG. 2 is an image obtained by cutting out a part of a screen displayed on the display. Meanwhile, the environment information is a captured image of the entire screen displayed on the display, and may be an image including a task bar of the OS, a toolbar of a browser or a predetermined application, and the like.

In the example of FIG. 3, the extraction unit 132 extracts a captured image 51b and operation content 52b in association with each other. The captured image 51b corresponds to the environment information. The operation content 52b corresponds to the action information.

It is assumed that, in order to input “yokosuka” in romaji, the worker first hits (presses) the “y” key on the keyboard in a text box 511b, and then hits the “o” key on the keyboard.

In this case, the operation content 52b includes that the type of the operation event is pressing of the “o” key.

In this case, for example, the environment before the action is taken is the captured image of the screen before the “o” key is pressed. On the other hand, the environment affected by the action is the captured image of the screen in a state where “yo” is input in the text box 511b after the “o” key is pressed. Note that, in the romaji input, “yo” in hiragana is displayed by inputting “o” after “y”.

Note that the extraction unit 132 may extract the entire captured image 51b as the environment information, or may extract the text box 511b that is a part of the captured image 51b and is an operation target as the environment information.

Note that the captured image 51b in FIG. 3 is an image obtained by cutting out a part of a screen displayed on the display. Meanwhile, the environment information is a captured image of the entire screen displayed on the display, and may be an image including a task bar of the OS, a toolbar of a browser or a predetermined application, and the like.

The extraction unit 132 may extract a series of multiple pieces of environment information in association with one piece of action information. For example, the extraction unit 132 can extract, as the environment information, captured images of multiple frames of screens in chronological order until predetermined operation content for the terminal device 20 occurs.

In addition, the extraction unit 132 may further extract environment information regarding an environment having a similarity to an environment corresponding to the extracted environment information greater than or equal to a threshold value in association with the action information.

For example, a past captured image similar to the captured image 51b may be extracted in addition to the captured image 51b in association with the operation content 52b.

For example, the number of words commonly shown in two captured images is set as the similarity. Then, the extraction unit 132 regards captured images having the similarity greater than or equal to the threshold value as being similar to each other.

That is, the extraction unit 132 extracts not only the environment information at the moment when the action indicated by the action information is performed but also similar environment information in the past.

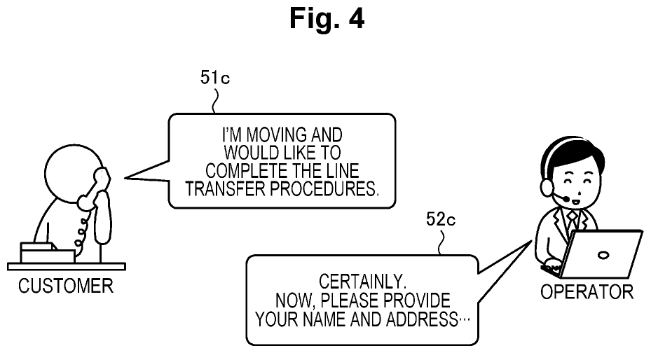

FIG. 4 illustrates an example of the environment information and the action information regarding the telephone support task.

In the example of FIG. 4, the extraction unit 132 extracts a voice 51c of a telephone inquiry from a customer and a voice 52c of an operator's answer in association with each other. The voice 51c corresponds to the environment information. The voice 52c corresponds to the action information.

At this time, the extraction unit 132 may extract text in which the voice is written instead of the voice.

In this case, for example, the environment before the action is taken is the voice 51c of the telephone inquiry from the customer. On the other hand, the environment affected by the action is a voice further uttered by the customer with respect to the voice 52c of the operator's answer.

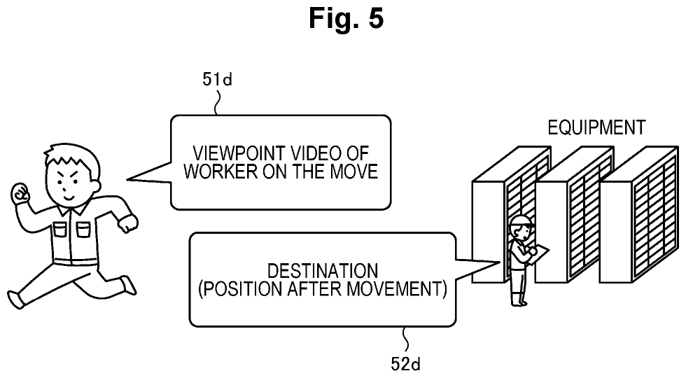

FIG. 5 illustrates an example of the environment information and the action information regarding an equipment inspection task.

In the example of FIG. 5, the extraction unit 132 extracts a video 51d of a viewpoint of a worker on the move and a position 52d of a destination to which the worker has moved in association with each other. The video 51d corresponds to the environment information. The position 52d corresponds to the action information.

In this case, for example, the environment before the action is taken is the video 51d of the viewpoint of the worker on the move. On the other hand, the environment affected by the action is a video of the viewpoint of the worker after the move.

The generation unit 133 generates an action series processed to be more effective for learning an action up to execution of processing related to the task, from actions indicated by the action information, on the basis of the environment information and the action information associated with each other by the extraction unit 132. The generation unit 133 performs processing of deletion and addition on the pieces of information associated with each other by the extraction unit 132, thereby omitting useless information and generating an action series more suitable for learning.

The generation unit 133 determines an action corresponding to a mistake among actions indicated by the action information on the basis of a predetermined determination rule, and deletes information regarding the action corresponding to the mistake. With respect to the action corresponding to the mistake, the generation unit 133 deletes not only the action information indicating the action but also the environment information corresponding to the action information. The generation unit 133 makes a determination on the basis of the following determination rule, for example.

The generation unit 133 extracts a specific action in the action series of the worker, and determines that the action or preceding and following actions are mistakes.

For example, in a case where the worker performs text input in terminal operation, and takes an action of pressing a “backspace key” or a “delete key”, it can be determined that the key input performed before the action is an operation mistake.

For this reason, in the determination rule, in a case where the action indicated by the action information is text input operation in terminal operation and is pressing of the “backspace key” or pressing of the “delete key”, it is set that the key input performed before the action is determined to be an operation mistake. Then, in the case where the action indicated by the action information is text input operation in terminal operation and is pressing of the “backspace key” or pressing of the “delete key”, the generation unit 133 determines that the key input performed before the action is an operation mistake, and deletes information regarding this action.

For example, in a case where a worker writes a word on paper with a pen, and takes an action such as deleting the written word or an action such as filling out the written word, it is possible to determine that the writing performed before the action is a mistake.

For this reason, in the determination rule, in a case where the action indicated by the action information is an action of writing a word on paper with a pen, and is an action of deleting the written word or an action of filling out the written word, it is set that the entry made before the action is determined to be a mistake. Then, in the case where the action indicated by the action information is an action of writing a word on paper with a pen, and is an action of deleting the written word or an action of filling out the written word, the generation unit 133 determines that the writing performed before the action is a mistake, and deletes information regarding this action.

In addition, the generation unit 133 compares pieces of environment information before and after the first environment information, and in a case where there is the same environment information, determines an action as being a mistake for an action corresponding to the first environment information or actions corresponding to the pieces of environment before and after the first environment information that are the same as the first environment information.

For example, in a case of an action of performing transition between pages in the terminal operation, in a case where a “return” button is immediately clicked by the worker, it can be determined that this page transition operation is an operation mistake.

For this reason, in the determination rule, in a case where the action indicated by the action information is an action of performing transition between pages in the terminal operation, and there is an action of clicking the “return” button within a predetermined time, it is set that this action of performing transition between pages is determined to be an operation mistake. Then, in the case where the action indicated by the action information is an action of performing transition between pages in the terminal operation, and there is an action of clicking the “return” button within the predetermined time, the generation unit 133 determines that the action of performing transition between pages is an operation mistake, and deletes the information regarding the action.

For example, in a case where the operator repeatedly performs explanation of the same content in telephone support, it can be determined that the speech other than the last explanation was that cannot be understood by the other party, for example, the content is insufficient, that is, the speech is a mistake.

For this reason, in the determination rule, in a case where the action indicated by the action information is an action in which the operator repeatedly performs explanation of the same content in telephone support, it is set that an action other than the last explanation is determined to be a mistake. Then, in the case where the action indicated by the action information is an action in which the operator repeatedly performs explanation of the same content in telephone support, the generation unit 133 determines that an action other than the last explanation is a mistake, and deletes information regarding this action.

In addition, in a case where specific information is included in the environment information, the generation unit 133 makes a determination as being a mistake for an action indicated by the action information associated with the environment information or actions before and after the action.

For example, in the terminal operation, in a case where wording such as “please redo . . . ” is included in the environment information, it can be inferred that any operation performed before that includes a mistake.

For this reason, in the determination rule, in the case where wording such as “please redo . . . ” is included in the environment information, it is set that it is determined that a mistake is included in any operation performed before that. In this case, the generation unit 133 determines which operation among any operations performed before that includes the mistake. Specifically, the generation unit 133 extracts an action similar to an action (operation) performed next by the worker from among any operations performed before that, specifies a mistake from a difference between the action performed next by the worker and the extracted action, and deletes information regarding the action specified as the mistake. For example, in a case where there is a mistake of inputting an incorrect value in some items in system input work, when work of redoing the system input is performed, it is predicted that an input operation of the same value is performed in redo work, for an item in which a correct value is input in the previous operation, and an operation of inputting a correct value different from the previous operation is performed, for an item in which the incorrect value is input in the previous operation. Thus, in a case where an environment similar to an action that may include a mistake appears during the redo work, it can be determined that the previous action is correct in a case where the same action is taken, and it can be determined that the previous action is incorrect in a case where a different action is taken. In this manner, the generation unit 133 specifies which operation is the mistake from the difference between the information associated with the action that may include the mistake and the information associated with the action taken during the redo work.

In addition, for example, in a case where a voice such as “please redo . . . ” is included as the environment information, it can be inferred that a mistake is included in any action performed before that.

For this reason, in the determination rule, in the case where a voice such as “please redo . . . ” is included in the environment information, it is set that it is determined that a mistake is included in any action performed before that. In the case where a voice such as “please redo . . . ” is included as the environment information, the generation unit 133 extracts information similar to information in the action performed next by the worker from among any actions performed before that. Then, the generation unit 133 specifies a mistake from a difference between the action performed next by the worker and the extracted action, and deletes information regarding the action specified as the mistake.

The generation unit 133 determines an action corresponding to a meaningless useless action among actions indicated by the action information on the basis of a predetermined determination rule, and deletes information regarding the action in a case where the action is a meaningless action. The generation unit 133 deletes action information indicating a meaningless action and environment information associated with the action information. The generation unit 133 makes a determination on the basis of the following determination rule, for example.

For example, the generation unit 133 sets pieces of environment information before and after an action on the basis of the collected action information and environment information, compares them, and determines the action as a meaningless action in a case where there is no change in the environment.

For example, in a case where the worker performs some operation in the terminal operation, in a case where no difference occurs between the screens before and after the operation, the operation can be inferred as meaningless operation.

For this reason, in the determination rule, in the case where the worker performs some operation in the terminal operation, in the case where no difference occurs between the screens before and after the operation, it is set that the operation is determined to be meaningless. In the case where no difference occurs between the screens before and after the operation, the generation unit 133 determines that the operation is a meaningless operation, and deletes information regarding this action.

For example, in a machine inspection task in field work, in a case where the worker moves in front of a machine and performs visual inspection, and then does not take an action such as reporting by utterance or writing on an inspection table, it can be inferred that the actions of the movement and the visual inspection are meaningless actions.

For this reason, in the determination rule, in the machine inspection task in the field work, in the case where the worker moves in front of a machine and performs visual inspection, and then does not take an action such as reporting by utterance or writing on an inspection table, it is set that the actions of the movement and the visual inspection are determined to be meaningless. In the determination rule, in the machine inspection task in the field work, in the case where the worker moves in front of a machine and performs visual inspection, and then does not take an action such as reporting by utterance or writing on an inspection table, the generation unit 133 determines that the actions of the movement and the visual action are meaningless operations, and deletes information regarding the actions.

Then, the generation unit 133 acquires actions from an operation log in chronological order, and generates an action series in which the number of steps of the acquired actions is minimized. The generation unit 133 arranges actions taken by the worker in chronological order on the basis of the operation log, and sets an action series in which the number of steps of those actions is minimized.

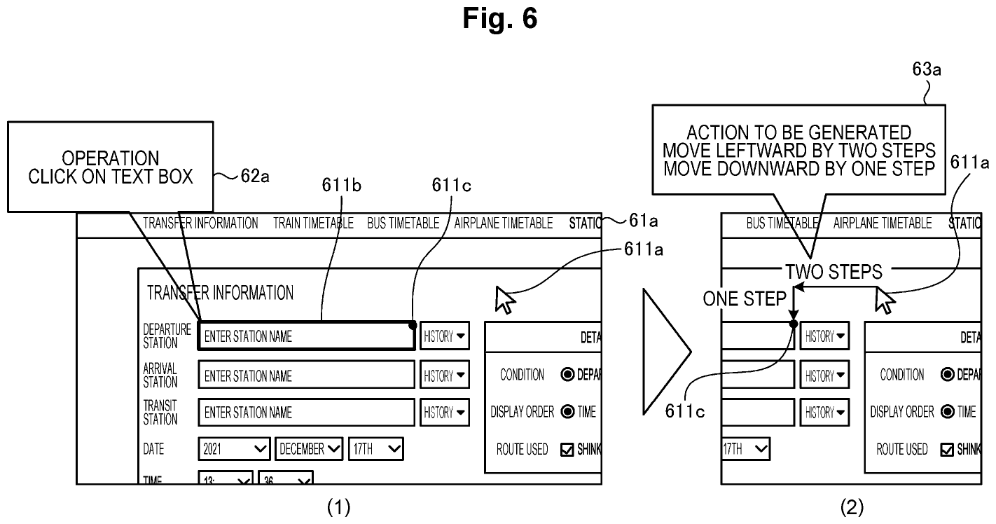

FIG. 6 is a diagram for describing processing performed by the generation unit 133. A description will be given of a case of operation content 62a in which, for example, a click on a text box is performed in the terminal operation, as an example.

The generation unit 133 extracts a captured image 61a of a terminal screen associated with the operation content 62a ((1) in FIG. 6). Then, the generation unit 133 detects, from cursor coordinates 611a of the captured image 61a, coordinates 611c closest to the cursor coordinates on a text box 611b on which a click is performed. Then, the generation unit 133 generates an action of cursor movement approaching the coordinates 611c.

The generation unit 133 generates an action series in which the number of movement steps from the cursor coordinates 611a to the coordinates 611c is minimized. Specifically, the generation unit 133 moves leftward by two steps from the cursor coordinates 611a and moves downward by one step to generate an action series reaching the coordinates 611c. Note that, on the terminal screen, movement by a predetermined unit of distance can be made in one step.

The design unit 134 designs an environment and a reward in the reinforcement learning of a model for executing a task on the basis of both the pieces of information associated with each other by the extraction unit 132 and information regarding the processing performed by the generation unit 133. The design unit 134 designs the environment and the reward for information other than the information deleted by the generation unit 133 among the action information and the environment information associated with each other by the extraction unit 132. Thus, the design unit 134 designs the environment and the reward by using an action other than an action that is a mistake and an action other than a meaningless action. Note that actions such as cursor movement set by the generation unit 133 to minimize the number of steps of actions are not used for designing reinforcement learning.

The design unit 134 assumes that an action indicated by the action information is a “correct action”, and in an environment when the action is taken, performs design so that a reward is given in a case where an agent takes a similar action.

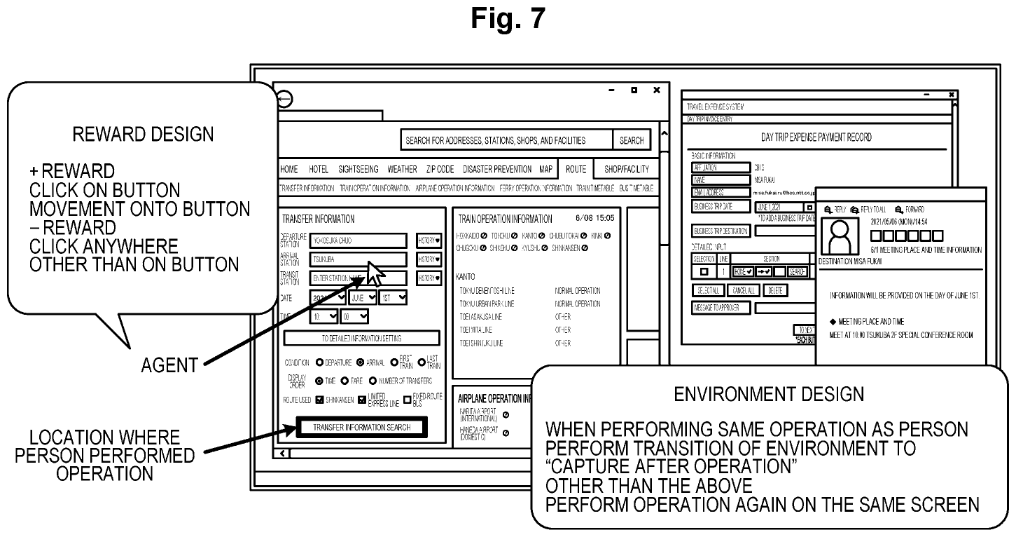

FIG. 7 is a diagram illustrating examples of environment design and action design. As illustrated in FIG. 7, the design unit 134 performs environment design and reward design.

For example, in a case where clicking a predetermined button is a “correct action”, the design unit 134 performs design so that a positive reward is given to an operation of clicking the button and moving a cursor onto the button. On the other hand, the design unit 134 performs design so that a negative reward (penalty) is given to an operation of clicking anywhere other than on the button.

Furthermore, the design unit 134 performs design so that transition of the environment to a captured image after the operation is performed in a case where the same operation as the worker, that is, clicking the button is performed, and transition of the environment is not performed and the agent is caused to execute the operation again on the same screen in a case where an operation other than clicking the button is performed.

Here, it is assumed that the extraction unit 132 extracts both environment information regarding an environment before an action is taken and environment information regarding an environment affected by the action. At this time, the design unit 134 performs design so that the environment before an action is taken is presented to the agent, and transition to the environment affected by the action is performed in a case where the agent takes a “correct action”.

Note that the design unit 134 stores contents of the design in the storage unit 12 as the learning information 121.

The learning unit 135 constructs a learning environment for performing the reinforcement learning of a model in accordance with the learning information 121. Before the agent performs trial and error on the environment prepared by the reinforcement learning, the learning unit 135 performs preliminary learning of what kind of action is appropriate by using the action series generated by the generation unit 133. Thereafter, the learning unit 135 performs the reinforcement learning of the model on the basis of the environment and the reward designed by the design unit 134. The learning unit 135 updates the model information 122 on the basis of a result of causing the agent to perform an action in the learning environment.

In a case where the task uses the terminal device 20, the learning unit 135 presents a captured image of the screen of the terminal device 20 to the agent as the environment, and causes the agent to select an action (click, cursor movement, or the like) to be taken on the captured image.

In a case where the task involves movement by walking, the learning unit 135 presents a moving image of the viewpoint of the worker who is walking or a still image cut out from the moving image to the agent as the environment, and causes the agent to select a direction in which the worker should proceed.

In this manner, by substituting the environment information on the worker during the task as the learning environment and causing the agent to take an action on the environment, it is possible to perform learning without affecting the actual task.

Note that the agent is a simulated subject that selects an action depending on an output of the model constructed from the model information 122.

In addition, the learning unit 135 may perform learning on the basis of the environment information and the action information regarding one worker. In this case, learning of action reflecting characteristics of each of workers can be expected.

Meanwhile, the learning unit 135 may perform learning by combining the environment information and the action information regarding a plurality of workers. In this case, more efficient learning of a work procedure can be expected.

The execution unit 136 generates a series of actions related to the task by using a model of which the reinforcement learning has been performed on the basis of the environment and the reward designed by the design unit 134.

For example, the execution unit 136 specifies an action on the basis of an output obtained by inputting environment information in an actual task into a learned model constructed from the model information 122.

Specifically, the execution unit 136 generates an action series from the environment information during the task of the worker by using the learned model, and assists in the task on the basis of the generated action series.

The assistance in the task may directly perform work or may provide an action to be taken in the task to the worker.

For example, the execution unit 136 performs automatic input to an item on the basis of a captured image of the screen of the terminal device. In addition, for example, the execution unit 136 may infer work to be performed next from a viewpoint video of the worker and provide information regarding the inferred work by voice.

### [Processing in First Embodiment]

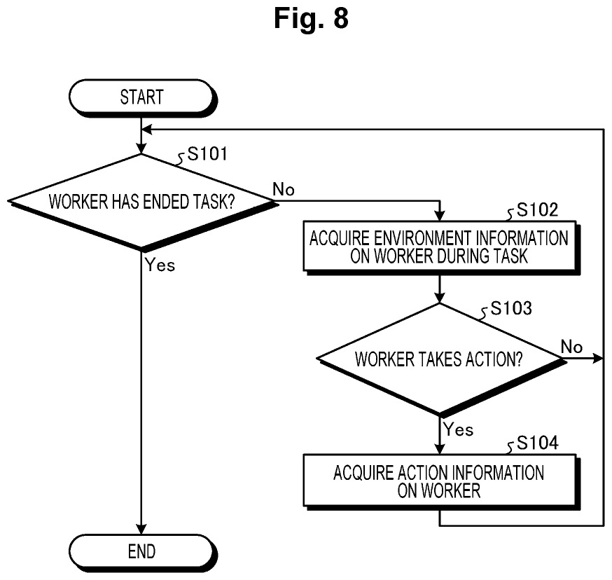

FIG. 8 is a flowchart illustrating a flow of acquisition processing. As illustrated in FIG. 8, in a case where the worker has not ended work (step S101, No), the acquisition unit 131 acquires environment information on the worker during the task (step S102).

Then, in a case where the worker takes an action (step S103, Yes), the acquisition unit 131 acquires action information on the worker (step S104).

In a case where the worker does not take an action (step S103, No), the acquisition unit 131 returns to step S101.

In a case where the worker has ended the work (step S101, Yes), the acquisition unit 131 ends the processing.

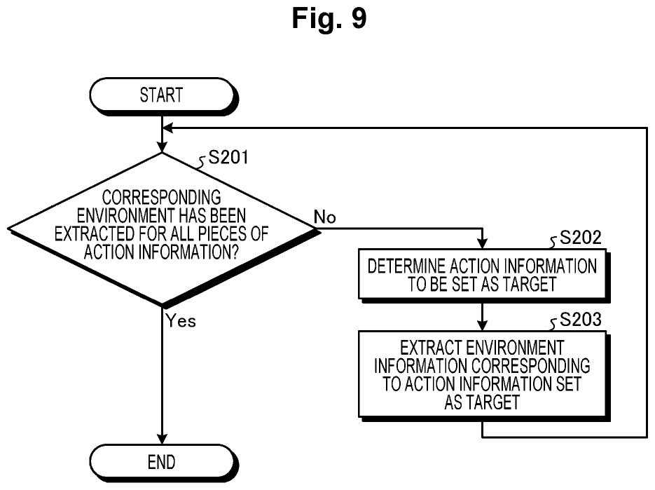

FIG. 9 is a flowchart illustrating a flow of extraction processing. In a case where a corresponding environment has not been extracted for all pieces of action information acquired by the acquisition unit 131 (step S201, No), the extraction unit 132 determines action information to be set as a target (step S202).

Then, the extraction unit 132 extracts environment information corresponding to the action information set as the target (step S203).

In a case where the corresponding environment has been extracted for all the pieces of action information acquired by the acquisition unit 131 (step S201, Yes), the extraction unit 132 ends the processing.

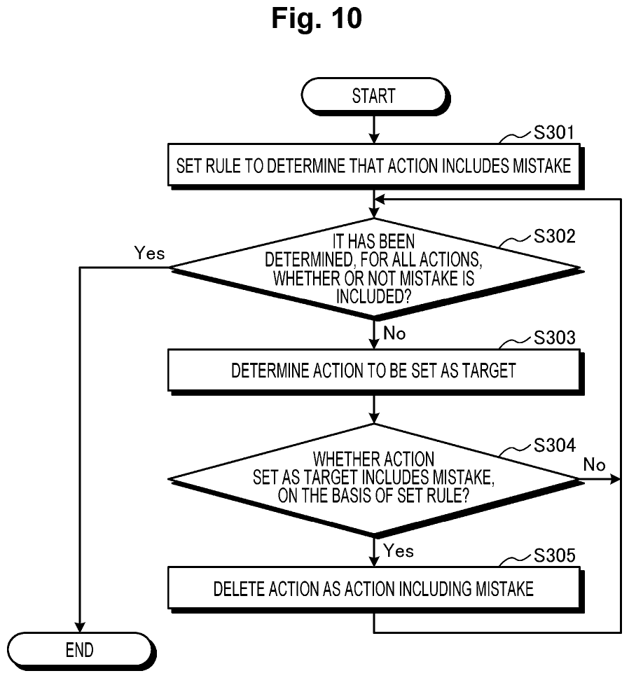

FIG. 10 is a flowchart illustrating an example of a flow of action deletion processing. As illustrated in FIG. 10, the generation unit 133 sets a determination rule to be used when determining that an action includes a mistake (step S301).

In a case where it has not been determined, for all actions, whether or not a mistake is included (step S302: No), the generation unit 133 determines action information to be set as a target (step S303).

The generation unit 133 determines whether or not the action set as the target includes a mistake on the basis of the set determination rule (step S304). In a case where it is determined that the action set as the target includes a mistake (step S304: Yes), the generation unit 133 deletes the action set as the target as an action including a mistake (step S305).

In a case where it is determined that the action set as the target does not include a mistake (step S304: No) or after the processing of step S305, the generation unit 133 returns to step S302.

In a case where it has been determined, for all the actions, whether or not a mistake is included (step S302: Yes), the generation unit 133 ends processing of deleting the action including the mistake.

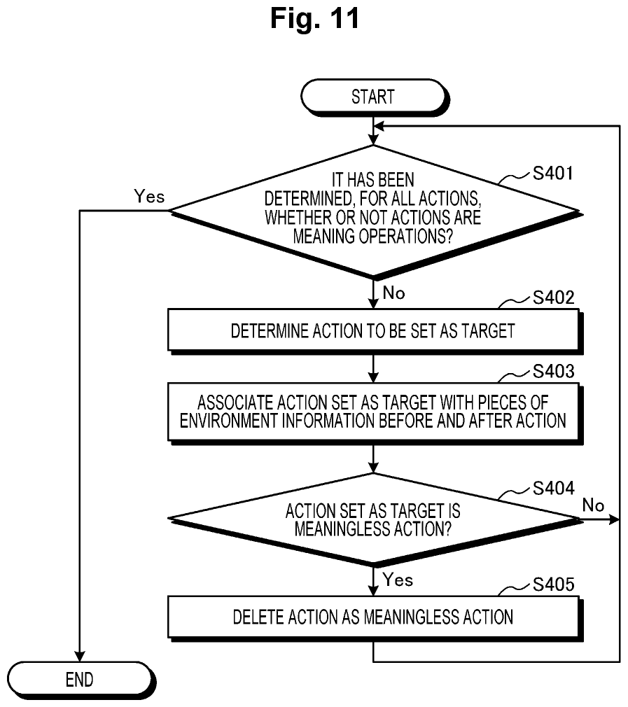

FIG. 11 is a flowchart illustrating an example of the flow of the action deletion processing. As illustrated in FIG. 11, in a case where it has not been determined, for all actions, whether or not the actions are meaningful operations (step S401: No), the generation unit 133 determines action information to be set as a target (step S402).

The generation unit 133 associates the action set as the target with pieces of environment information before and after the action (step S403). The generation unit 133 determines whether or not the action set as the target is a meaningless action (step S404). In a case where there is no change between environments of the pieces of environment information before and after the action, the generation unit 133 determines that the action is a meaningless action.

In a case where the action set as the target is a meaningless action (step S404: Yes), the generation unit 133 deletes the action as a meaningless action (step S405).

In a case where the action set as the target is not a meaningless action (step S404: No) or after the processing of step 405, the generation unit 133 returns to step S401.

In a case where it has been determined, for all the actions, whether or not the actions are meaningful operations (step S401: Yes), the generation unit 133 ends processing of deleting a meaningless action.

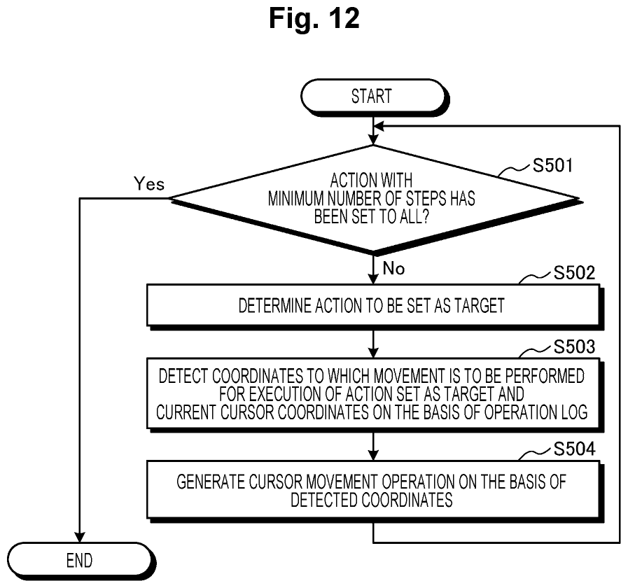

FIG. 12 is a flowchart illustrating a flow of processing of minimizing the number of steps of actions. As illustrated in FIG. 12, in a case where an action with a minimum number of steps has not been set to all (step S501: No), the generation unit 133 determines action information to be set as a target (step S502).

The generation unit 133 detects coordinates to which movement is to be performed for execution of the action set as the target and current cursor coordinates on the basis of the operation log (step S503). The generation unit 133 generates a cursor movement operation on the basis of the detected coordinates (step S504).

In a case where an action with a minimum number of steps has been set to all (step S501: Yes), the generation unit 133 ends the processing of minimizing the number of steps of actions.

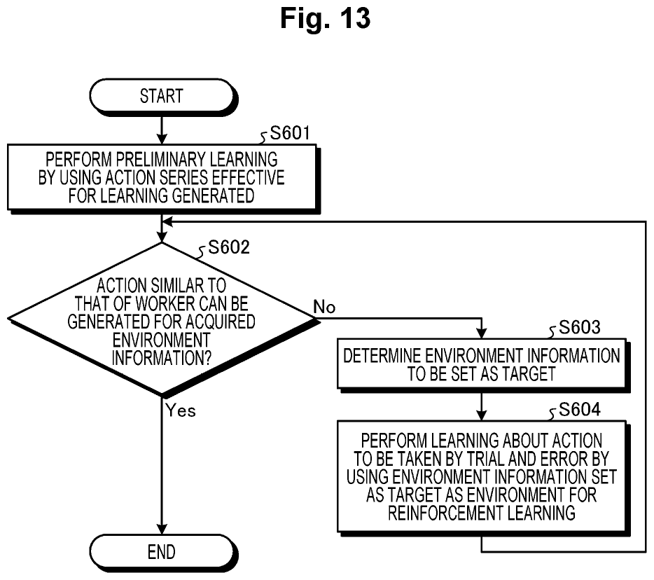

FIG. 13 is a flowchart illustrating a flow of learning processing. Here, it is assumed that the reward and the environment for the reinforcement learning have been designed by the design unit 134.

As illustrated in FIG. 13, the learning unit 135 performs preliminary learning of what kind of action is appropriate by using the action series effective for learning generated by the generation unit 133 (step S601). Thereafter, in a case where an action similar to that of the worker cannot be generated for the acquired environment information (step S602, No), the learning unit 135 determines environment information to be set as a target (step S603).

The learning unit 135 performs learning about an action to be taken by trial and error by using the environment information set as the target as an environment for the reinforcement learning (step S604). The learning unit 135 updates the model information 122 on the basis of a result of the learning.

In a case where an action similar to that of the worker can be generated for the acquired environment information (step S602, Yes), the learning unit 135 ends the processing.

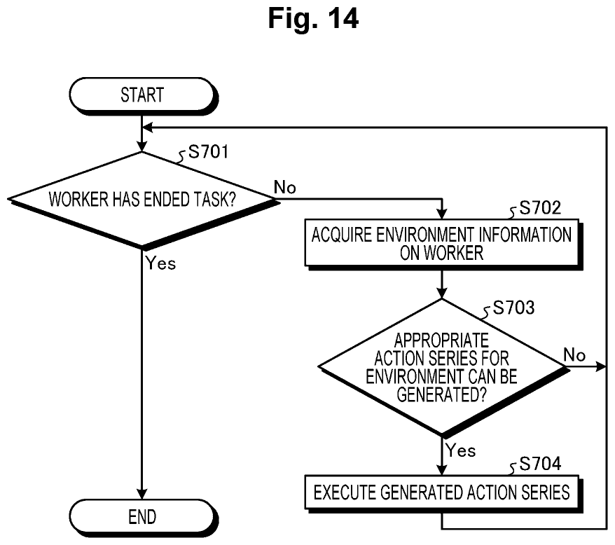

FIG. 14 is a flowchart illustrating a flow of execution processing. Here, it is assumed that the execution unit 136 constructs the learned model from the model information 122.

As illustrated in FIG. 14, in a case where the worker has not ended one's task (step S701, No), the execution unit 136 acquires environment information on the worker (step S702).

Then, in a case where an appropriate action series for the environment can be generated (step S703, Yes), the execution unit 136 executes the action series generated by using the model (step S704).

In a case where an appropriate action series for the environment cannot be generated (step S703, No), the execution unit 136 returns to step S701.

In a case where the worker has ended the task (step S701, Yes), the execution unit 136 ends the processing.

### Effects of First Embodiment

As described above, the acquisition unit 131 acquires environment information that is information regarding an environment in a task and action information that is information regarding an action in the task. The extraction unit 132 extracts the environment information and the action information in association with each other. The generation unit 133 generates an action series processed to be more effective for learning an action up to execution of processing related to the task, from actions indicated by the action information, on the basis of the environment information and the action information associated with each other by the extraction unit 132. The design unit 134 designs the environment and the reward in the reinforcement learning of the model for executing the task on the basis of both the pieces of information associated with each other by the extraction unit 132 and the information regarding the processing performed by the generation unit 133, thereby appropriately performing design for the reinforcement learning.

Then, the learning unit 135 performs preliminary learning of what kind of action is appropriate by using the action series generated by the generation unit 133, and then performs the reinforcement learning of the model on the basis of the environment and the reward designed by the design unit 134.

In this manner, the assistance device 10 performs preliminary learning by using an action series processed to be more effective for learning an action up to execution of processing related to the task. Thus, the assistance device 10 can perform learning of an appropriate action for complicated environments and actions by processing the action of the worker into an action series more effective for learning and performing preliminary learning, by application of reinforcement learning to the task. As a result, according to the assistance device 10, assistance such as automation can be performed for a complicated task performed by a person.

The acquisition unit 131 acquires information regarding an action of a worker who performs the task as the action information, and can acquire information on an environment regarding the worker as the environment information. In this way, the action information and the environment information can be easily acquired by focusing on the action and the environment of the worker.

In addition, the acquisition unit 131 acquires a content of an operation on the terminal device 20 by the worker as the action information, and acquires a state of the terminal device 20 that changes depending on the operation by the worker as the environment information. As a result, it is possible to easily acquire the environment information regarding the task using the terminal device.

In addition, the extraction unit 132 extracts first action information regarding an action in the task and first environment information regarding at least one of an environment before the action is taken or an environment affected by the action in association with each other. As a result, it is possible to easily design reinforcement learning from related action information and environment information.

In addition, the extraction unit 132 further extracts second environment information regarding an environment having a similarity to the environment greater than or equal to a threshold value in association with the first action information. In this way, multiple pieces of environment information similar to the action information are associated with each other, whereby the accuracy of the reinforcement learning can be improved.

In addition, the generation unit 133 determines an action corresponding to a mistake, and deletes action information regarding the action corresponding to the mistake and environment information associated with the action information. As a result, the assistance device 10 can more efficiently learn an action up to execution of processing related to the task.

In addition, the generation unit 133 determines a meaningless action with no change between environments indicated by pieces of environment information before and after the action, and deletes action information regarding the meaningless action and environment information associated with the action information. As a result, the assistance device 10 can more efficiently learn an action up to execution of processing related to the task.

In addition, the generation unit 133 generates an action series in which the number of steps of actions is minimized. As a result, since the assistance device 10 performs preliminary learning on the basis of the actions with the minimized number of steps, it is possible to efficiently perform preliminary learning.

In addition, the execution unit 136 generates a series of actions related to the task by using a model of which the reinforcement learning has been performed on the basis of the environment and the reward designed by the design unit 134. Thus, it is possible to reduce human work and judgment related to the task.

### [System Configuration and Others]

In addition, each of components of the illustrated devices is functionally conceptual, and does not necessarily need to be physically configured as illustrated. That is, a specific form of distribution and integration of the devices is not limited to the illustrated form, and can be configured by functionally or physically distributing or integrating all or some thereof in any unit depending on various loads, use status, and the like. Furthermore, the whole or any part of processing functions performed in the devices can be implemented by a central processing unit (CPU) and a program analyzed and executed by the CPU, or can be implemented as hardware by wired logic. Note that the program may be executed not only by a CPU but also by another processor such as a GPU.

In addition, among the pieces of processing described in the present embodiment, all or some of the pieces of processing described as being automatically performed can be manually performed, or all or some of the pieces of processing described as being manually performed can be automatically performed by a known method. In addition, processing procedures, control procedures, specific names, and information including various data and parameters described in the above document and drawings can be arbitrarily changed unless otherwise specified.

### [Program]

As an embodiment, the assistance device 10 can be implemented by installing, as packaged software or online software, an assistance program for executing assistance processing described above in a desired computer. For example, an information processing device is caused to execute the assistance program, whereby the information processing device can be caused to function as the assistance device 10. The information processing device mentioned here includes a desktop or a laptop personal computer. In addition, the information processing device also includes a mobile communication terminal such as a smartphone, a mobile phone, and a personal handyphone system (PHS), a slate terminal such as a personal digital assistant (PDA), and the like.

In addition, the assistance device 10 can also be implemented as an assistance server device that sets a terminal device used by a user as a client and provides the client with a service related to the assistance processing described above. For example, the assistance server device is implemented as a server device that provides an assistance service in which action information and environment information in a task are input and a learned model for assisting in the task is output. In this case, the assistance server device may be implemented as a web server or may be implemented as a cloud that provides a service related to the assistance processing described above by outsourcing.

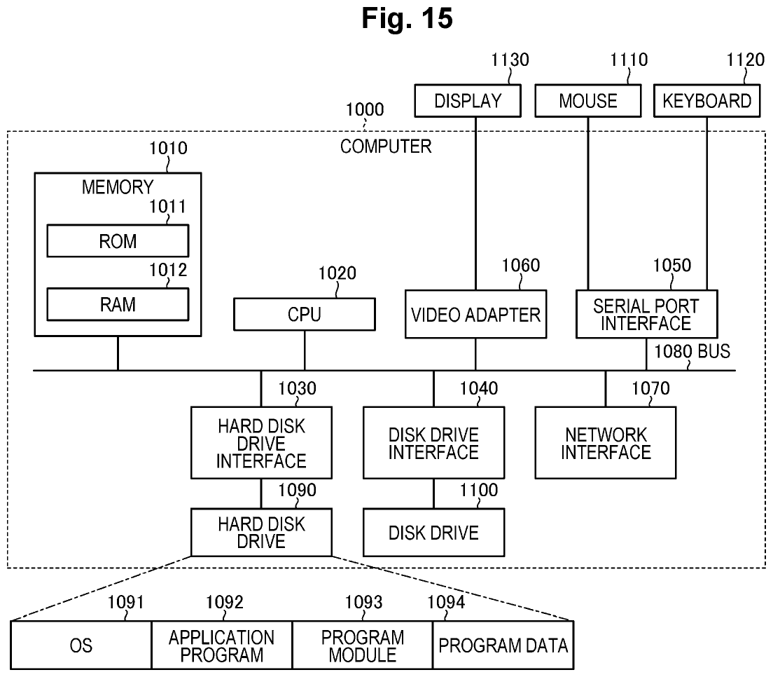

FIG. 15 is a diagram illustrating an example of a computer that executes the assistance program. A computer 1000 includes a memory 1010 and a CPU 1020, for example. In addition, the computer 1000 includes a hard disk drive interface 1030, a disk drive interface 1040, a serial port interface 1050, a video adapter 1060, and a network interface 1070. These units are connected to each other via a bus 1080.

The memory 1010 includes a read only memory (ROM) 1011 and a random access memory (RAN) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, a program that defines the pieces of processing of the assistance device 10 is implemented as the program module 1093 in which a code executable by a computer is described. The program module 1093 is stored in, for example, the hard disk drive 1090. For example, the program module 1093 for executing processing similar to functional components in the assistance device 10 is stored in the hard disk drive 1090. Note that the hard disk drive 1090 may be replaced with a solid state drive (SSD).

In addition, setting data used in the processing in the embodiment described above is stored in, for example, the memory 1010 or the hard disk drive 1090 as the program data 1094. Then, the CPU 1020 reads the program module 1093 and the program data 1094 stored in the memory 1010 or the hard disk drive 1090 to the RAM 1012 as necessary and executes the processing in the embodiment described above.

Note that the program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (local area network (LAN), wide area network (WAN), or the like). Then, the program module 1093 and the program data 1094 may be read by the CPU 1020 from another computer via the network interface 1070.

### REFERENCE SIGNS LIST

1 Assistance system
10 Assistance device
11 Input/output unit
12 Storage unit
13 Control unit
20 Terminal device
51a, 51b, 61a Captured image
51c, 52c Voice
51d Video
52a, 52b, 62a Operation content
52d Position
121 Learning information
122 Model Information
131 Acquisition unit
132 Extraction unit
133 Generation unit
134 Design unit
135 Learning unit
136 Execution unit
511a Button
511b Text box

1. An assistance device comprising:
an acquisition unit, implanted using one or more processors, configured to acquire (i) environment information that is information regarding an environment in a task and (ii) action information that is information regarding an action in the task;
an extraction unit, implemented using one or more processors, configured to extract the environment information and the action information in association with each other;
a generation unit, implemented using one or more processors, configured to generate an action series processed to be more effective for learning an action up to execution of processing related to the task, from actions included in the action information, on a basis of the environment information and the action information;
a design unit, implemented using one or more processors, configured to design an environment and a reward in reinforcement learning of a model for executing the task on a basis of a combination of the environment information and the action information associated with each other by the extraction unit, and information regarding processing performed by the generation unit; and
a learning unit, implemented using one or more processors, configured to performs preliminary learning of what kind of action is appropriate by using the action series generated by the generation unit and then performs the reinforcement learning of the model on a basis of the environment and the reward designed by the design unit.

2. The assistance device according to claim 1, wherein the acquisition unit is configured to:
acquire information regarding an action of a worker who performs the task as the action information,
acquire information on an environment regarding the worker as the environment information, acquires a content of an operation on a terminal device by the worker as the action information, and
acquire a state of the terminal device that changes depending on the operation by the worker as the environment information.

3. The assistance device according to claim 1, wherein the extraction unit is configured to:
extract first action information regarding an action in the task and first environment information regarding at least one of an environment before the action is taken or an environment affected by the action in association with each other, and
extract second environment information regarding an environment having a similarity to the environment greater than or equal to a threshold value in association with the first action information.

4. The assistance device according to claim 1, wherein the generation unit is configured to determine an action corresponding to a mistake among actions indicated by the action information on a basis of a predetermined determination rule, and delete action information regarding the action corresponding to the mistake and environment information associated with the action information.

5. The assistance device according to claim 1, wherein the generation unit is configured to delete action information regarding an action with no change between environments indicated by pieces of the environment information before and after the action and environment information associated with the action information.

6. The assistance device according to claim 1, wherein the generation unit is configured to acquire the action in chronological order, and generate the action series in which a number of steps of acquired actions is minimized.

7. The assistance device according to claim 1, further comprising an execution unit configured to generate a series of actions related to the task by using a model of which the reinforcement learning has been performed on a basis of the environment and the reward designed by the design unit.

8. An assistance method executed by an assistance device, the assistance method comprising:
acquiring environment information that is information regarding an environment in a task and action information that is information regarding an action in the task;
extracting the environment information and the action information in association with each other;
generating an action series processed to be more effective for learning an action up to execution of processing related to the task, from actions included in the action information, on a basis of the environment information and the action information;
designing an environment and a reward in reinforcement learning of a model for executing the task on a basis of a combination of the environment information and the action information associated with each other, and information regarding execution of the processing performed; and
performing preliminary learning of what kind of action is appropriate by using the action series and then performing the reinforcement learning of the model on a basis of the environment and the reward designed.

9. A non-transitory computer readable medium storing an assistance program that upon execution by a computer, causes the computer to perform operations comprising:
acquiring environment information that is information regarding an environment in a task and action information that is information regarding an action in the task;
extracting the environment information and the action information in association with each other;
generating an action series processed to be more effective for learning an action up to execution of processing related to the task, from actions included in the action information, on a basis of the environment information and the action information;
designing an environment and a reward in reinforcement learning of a model for executing the task on a basis of a combination of the environment information and the action information associated with each other, and information regarding execution of the processing performed; and
performing preliminary learning of what kind of action is appropriate by using the action series and then performing the reinforcement learning of the model on a basis of the environment and the reward designed.

10. The non-transitory computer readable medium of claim 9, wherein the assistance program causes the computer to perform operations comprising:
acquiring information regarding an action of a worker who performs the task as the action information,
acquiring information on an environment regarding the worker as the environment information, acquires a content of an operation on a terminal device by the worker as the action information, and
acquiring a state of the terminal device that changes depending on the operation by the worker as the environment information.

11. The non-transitory computer readable medium of claim 9, wherein the assistance program causes the computer to perform operations comprising:
extracting first action information regarding an action in the task and first environment information regarding at least one of an environment before the action is taken or an environment affected by the action in association with each other, and
extracting second environment information regarding an environment having a similarity to the environment greater than or equal to a threshold value in association with the first action information.

12. The assistance device according to claim 9, wherein the assistance program causes the computer to perform operations comprising:
determining an action corresponding to a mistake among actions indicated by the action information on a basis of a predetermined determination rule; and
deleting action information regarding the action corresponding to the mistake and environment information associated with the action information.

13. The assistance device according to claim 9, wherein the assistance program causes the computer to perform operations comprising deleting action information regarding an action with no change between environments indicated by pieces of the environment information before and after the action and environment information associated with the action information.

14. The assistance device according to claim 9, wherein the assistance program causes the computer to perform operations comprising:
acquiring the action in chronological order; and
generating the action series in which a number of steps of acquired actions is minimized.

15. The assistance device according to claim 9, wherein the assistance program causes the computer to perform operations comprising generating a series of actions related to the task by using a model of which the reinforcement learning has been performed on a basis of the environment and the reward designed by the design unit.
